(19) United States
(12) Patent Application Publication
(10) Pub. No.: US 2009/0202220 A1
(43) Pub. Date: Aug. 13, 2009

(54) SYSTEM AND METHOD FOR CREATION OF A CUE SHEET FOR MUSIC AND OTHER ASSET LICENSING USING AN EDIT DECISION LIST REVERSE SEARCH

(76) Inventor: AMNON SARIG, Woodland Hills, CA (US)

Correspondence Address: Naomi Assia Law Offices;C/O Landon IP Inc., Suite 450, 1700 Diagonal Road, Alexandria, VA, 22314, US

(21) Appl. No.: 11/941,088

(22) Filed: Nov. 16, 2007

Related U.S. Application Data
(60) Provisional application No. 60/972,134, filed on Sep. 13, 2007.

(51) Int. Cl. H04N 5/93

(52) U.S. Cl. 386/55

(57) ABSTRACT

A method to enable automatic creation of a cue sheet for reporting of digital assets used in production. The method begins by parsing an Edit Decision List having codes containing a digital asset file and the duration of time that file was used in the production process. The method also includes using the codes as a key for searching a database of rights' owners, the search returning owners' and other identifying information. The identifying information includes at least composer name, publisher name, and at least one appropriate authority. The next step provides for using the identifying information to create a legal cue sheet for reporting of the digital assets.

### CROSS REFERENCE TO RELATED APPLICATION

This application claims priority from U.S. Provisional Patent Application No. 60/972,134, filed Sep. 13, 2007, which is hereby incorporated by reference in its entirety.

### FIELD OF THE INVENTION

The present invention relates generally to a real-time access to digital multimedia files over a communications network, and more particularly to a system, method for creation of a cue sheet for music and other asset licensing using an edit decision list reverse search.

### BACKGROUND OF THE INVENTION

When the timelines of edited film sequences are exported they are flattened into an “Edit Decision List” that is somewhat analogous to a musical playlist. The creation of cue sheets often stems from the composer or music editor's spotting notes or edit decision list (EDL). Playlists are a way to “make everyone a DJ.” An EDL is essentially an ordered list of sound bite sequences. A playlist could be used to make lyrical edits or remixes of existing material. The power of playlists enables sharing of knowledge that is aggregated by domain experts.

Thus, it would be desirable to provide a method and a system for converting an EDL into standard cue sheet format.

### SUMMARY OF THE INVENTION

Accordingly, it is a principal object of the present invention to provide a method and a system for converting an EDL into standard cue sheet format.

It is another principal object of the present invention to allow automatic creation of cue sheet reporting of digital asset used in production.

A method is provided to enable automatic creation of a cue sheet for reporting of digital assets used in production. The method begins with the parsing an Edit Decision List having codes containing a digital asset file and the duration of time that file was used in the production process. The method also includes using the codes as a key for searching a database of rights' owners, the search returning owners' and other identifying information. The identifying information includes at least composer name, publisher name, and at least one appropriate authority. The next step provides for using the identifying information to create a legal cue sheet for reporting of the digital assets.

A local computer containing software for audio and/or video editing creates an Edit Decision List (EDL) as part of its normal operation. The EDL has embedded time codes and file name codes used in the production of a video, audio or audiovisual program.

A computer program operating on the local computer, accesses a database containing codes matching the file name list from the EDL, then searches to find information about the asset used in the production, for example, a music track in digital file form.

The database is searched and the duration of each use is calculated, finding the information needed to accurately report the usage of the digital asset to the right authorities and other owners or trackers of such usage.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a flow chart illustrating the transformation from an edit decision list (EDL) to a cue sheet diagram, constructed in accordance with the principles of the present invention; and

FIG. 2 is a screenshot illustrating use of the software of the present invention to produce a legal cue sheet; and

FIG. 3 is a schematic block diagram illustrating an exemplary system for transformation from an edit decision list (EDL) to a cue sheet diagram, constructed in accordance with the principles of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

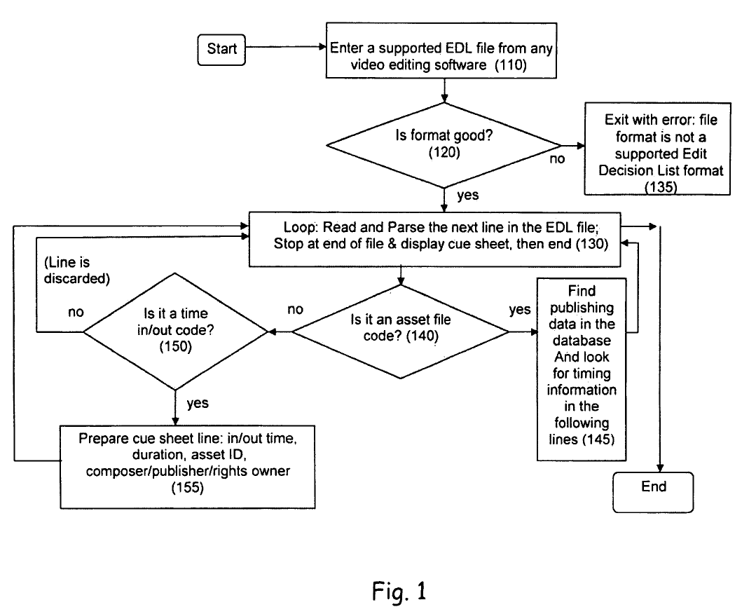

FIG. 1 is a flow chart illustrating the transformation from an edit decision list (EDL) to a cue sheet diagram, constructed according to principles of the present invention. To Start, one enters a supported EDL file from any video editing software 110. If the format is good 120, then Loop: Read and Parse the next line in the EDL file; Stop at the end of the file and display the cue sheet, then end 130. If the format is not good then Exit with error: file format is not a supported Edit Decision List format 135 and then End. Otherwise if it is an asset file code 140, then Find the publishing data in the database 145 and continue to loop 130. If it is not an asset file code 140 then is it a time in/out code? 150. If it is a time in/out code, then Prepare the cue sheet line: in/out time, duration, asset ID, composer/publisher/rights owner 155, and continue to loop 130.

### Sample:

Using an existing proprietary software product named MusicCue, the system collects EDL from an AVID video editor. AVID Liquid software is a powerful Standard Definition (SD) and High Definition (HD) video editor for the PC that combines integrated DVD authoring, surround-sound audio processing and thousands of effects in one application designed for real-world video production. An exemplary EDL is as follows:

EDT REL MODE TYP P S T P-VTR IN P-VTR OUT R-VTR IN R-VTR
OUT
MASTER RECORDER REEL MAST
BLOCK 001

BLEND, AUDIO DISSOLVE
TO CLIP NAME: FAL 5A049-01 AboveGra;0101.WAV

0001 BLK A1 C 00:00:00.00 00:00:00.00 01:00:00.26 01:00:00.26
0001 0039 A1 D 00:02 01:33:06,24 01:33:08,18 01:00:00.26
01:00:02.20

FROM CLIP NAME: GOSSAGE, GOOSE.NEW.06

0002 8676 V C 03:54:43,21 03:54:45,15 01:00:00.27 01:00:02.21

BLEND, AUDIO DISSOLVE
FROM CLIP NAME: FAL 5A013-14 DirkDagg;1401.WAV
TO CLIP NAME: FAL 5A013-14 DirkDagg;1401.WAV

0003 0039 A1 C 01:33:08,18 01:33:08,18 01:00:02.20 01:00:02.20
0003 0039 A1 D 00:02 01:35:50,00 01:35:52,04 01:00:02.20
01:00:04.24

FROM CLIP NAME: GOSSAGE, GOOSE.NEW.11

0004 0676 V C 01:00:13,25 01:00:15,08 01:00:02.21 01:00:05.01
DM+060

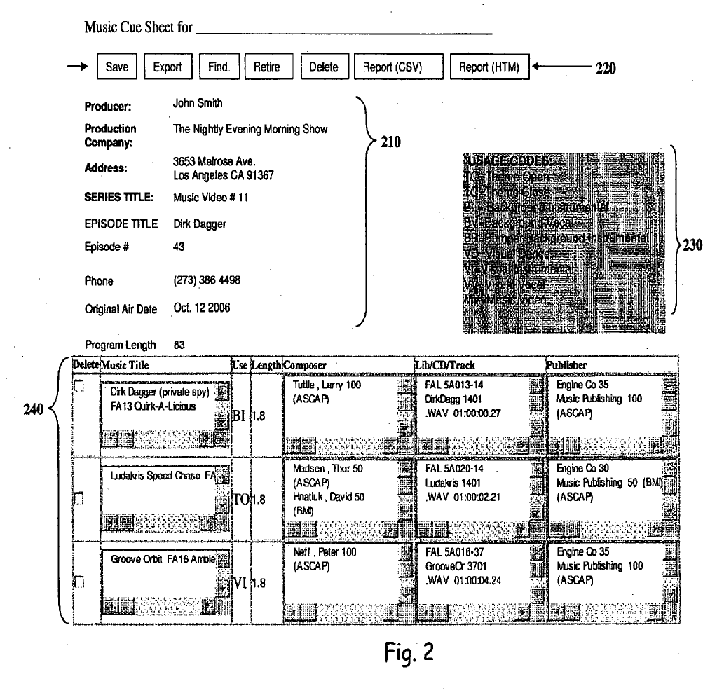

FIG. 2 is a screenshot illustrating use of the software of the present invention to produce a legal cue sheet from an Edit Decision List, such as that of the above sample. Music Cue Sheet 200 includes identifying information 210, actions 220, usage codes 230 and an action information block 240.

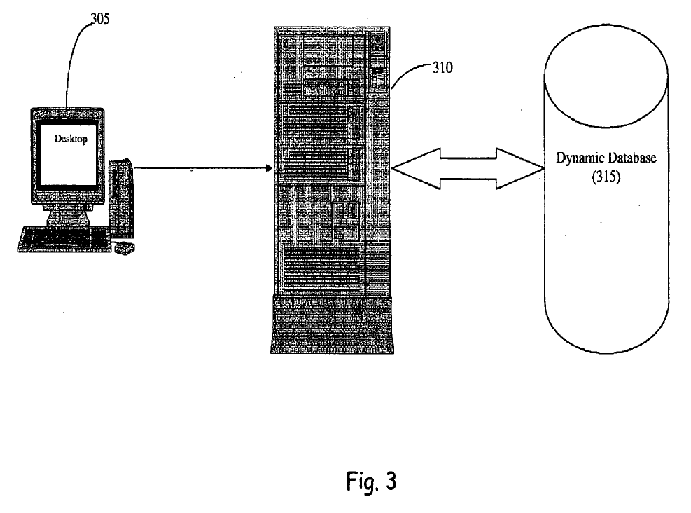

FIG. 3 is a schematic block diagram illustrating an exemplary system for transformation from an edit decision list (EDL) to a cue sheet diagram, constructed in accordance with the principles of the present invention. A local interpreting computer 305 containing software for audio and/or video editing creates an Edit Decision List (EDL) as part of its normal operation. The software may reside on a server 310. The EDL has embedded time codes and file name codes used in the production of a video, audio or audiovisual program.

A computer program operating on local interpreting computer 305, accesses a database 315 containing codes matching the file name list from the EDL, then searches to find information about the asset used in the production, for example, a music track in digital file form.

Database 315 is searched and the duration of each use is calculated, finding the information needed to accurately report the usage of the digital asset to the right authorities and other owners or trackers of such usage.

In alternative embodiment one can upload an EDL over the Internet to a public server component of the present invention, located at a proprietary Website, in order to produce a cue sheet diagram. The EDL can also be entered to an organization intranet computer.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method to enable automatic creation of a cue sheet for reporting of digital assets used in production, said method comprising:
parsing an Edit Decision List (EDL) gives codes containing a digital asset file and the duration of time that file was used in the production;
using said codes as a key for searching a database of rights' owners, said search returning owners' and other identifying information, comprising at least composer name, publisher name, and at least one appropriate authority; and
using said identifying information to create a legal cue sheet for reporting of the digital assets.

2. The method of claim 1, wherein said parsing is done on a local computer.

3. The method of claim 1, wherein said parsing is done on a network computer.

4. The method of claim 1, wherein said parsing is done by uploading said EDL over the Internet to a public proprietary server.

5. A system to enable automatic creation of a cue sheet for reporting of digital assets used in production, said system comprising:
means for parsing an Edit Decision List (EDL) gives codes containing a digital asset file and the duration of time that file was used in the production;
means for using said codes as a key for searching a database of rights' owners, said search returning owners' and other identifying information, comprising at least composer name, publisher name, and at least one appropriate authority; and
means for using said identifying information to create a legal cue sheet for reporting of the digital assets.

6. The system of claim 5, wherein said parsing means is a local computer.

7. The method of claim 1, wherein said parsing means is a network computer.

8. The method of claim 1, wherein said parsing is done by uploading said EDL over the Internet to said parsing means comprising a public proprietary server.

9. A computer program product to enable automatic creation of a cue sheet for reporting of digital assets used in production, said computer program product comprising:
means for parsing an Edit Decision List (EDL) gives codes containing a digital asset file and the duration of time that file was used in the production;
means for using said codes as a key for searching a database of rights' owners, said search returning owners' and other identifying information, comprising at least composer name, publisher name, and at least one appropriate authority; and
means for using said identifying information to create a legal cue sheet for reporting of the digital assets.

10. The computer program product of claim 9, wherein said parsing means is a local computer.

11. The method of claim 9, wherein said parsing means is a network computer.

12. The method of claim 9, wherein said parsing is done by uploading said EDL over the Internet to said parsing means comprising a public proprietary server.
